(19) United States
(12) Patent Application Publication
(10) Pub. No.: US 2008/0126283 A1
(43) Pub. Date: May 29, 2008

(54) Method of capturing Problem Resolution for Subsequent Use in Managed Distributed Computer Systems

(76) Inventors: Michael L. Odom, Austin, TX (US); Jesus Alberto Saenz, Austin, TX (US)

Correspondence Address: IBM CORP (YA);C/O YEE & ASSOCIATES PC, P.O. BOX 802333, DALLAS, TX, 75380, US

(21) Appl. No.: 11/531,010

(22) Filed: Sep. 12, 2006

(51) Int. Cl. G06N 5/00

(52) U.S. Cl. 706/45; 700/90

(57) ABSTRACT

A method and apparatus is provided for use in resolving problems in an event managed IT or computer system that has very unique characteristics. When the system operator is alerted to a problem, the workflow of the operator is captured, as the operator carries out a succession of corrective actions to fix the problem. The captured workflow is then stored with a signature identifying the problem, for use if a similar problem occurs later. One embodiment of the invention discloses a method that comprises identifying a system problem having a characteristic signature, and performing a succession of steps to fix the problem. A record is made of the succession of steps as they are respectively performed, and the succession of steps is stored together with the problem signature. The signature can identify a similar problem in the future, which can then be fixed using the succession of steps.

### BACKGROUND OF THE INVENTION

1. Field of the Invention

The invention disclosed and claimed herein generally pertains to a method for problem resolution in a highly specific information technology (IT) system environment. More particularly, the invention pertains to a method of the above type wherein the information technology system is managed by a distributed Systems Management software. Even more particularly, the invention pertains to a method of the above type wherein a signature characterizing the problem is also recorded, for future use in identifying the same or similar problem, so that the captured solution can be applied thereto.

2. Description of the Related Art

In an information technology or computer system managed by a distributed Systems Management software, it is common to provide an event console that is associated with the software managing the IT system. The console is used by an operator to monitor events of different kinds that occur in the system. The system may also include tools that send out alarms or notice of events that indicate the occurrence of particular problems. When the operator is notified of a problem in the system, such as by receiving an event or pattern of events, he must endeavor to fix or resolve the problem. If he cannot do so, he generally will need to refer the problem to a higher level operator.

Most systems management vendors provide some form of static instructions for dealing with a problem, wherein the instructions are provided to the operator along with notice of the problem. The static instructions typically need to be manually entered by the operator or systems management administrator.

Another popular functionality is to execute a script or batch file, when an indication of a particular problem is received. However, the scripts or batch files must be written and tailored for each problem event or resource. Moreover, the script or batch files provided with software or hardware tend to be very general purpose. Accordingly, they typically do not account for system variations, such as differences in components from different manufacturers, specific naming practices within an organization's computer environment or procedures that are uniquely required in a particular computer or information technology system. For example, a batch file can be created that starts and stops all printers in a system. However, if there was a problem with a particular printer, the operator would still need to know the identity of the manufacturer of the particular printer, in order to use the file to fix the problem. As another example, fixing a problem in a particular system might require sending the fix through an approval procedure that the generalized batch file was not aware of. Again, operator input would be required, in order to use the batch file.

More generally, in a particular IT system or environment having unique characteristics, it is likely that generalized scripts or batch files will require a human subject matter expert (SME) to expend time, in order to understand the flow of the environment. Such understanding is necessary to enable the SME to articulate possible actions that could resolve a system problem. From a business perspective, the SME becomes a critical resource, and the ability to improve the instructions or actions for resolution is dependent on the knowledge and skills of the SME.

Accordingly, it would be very beneficial to provide a procedure or means that tracks and records the actions of an SME, as he works to fix a problem in a unique IT system environment. The fix could then be stored in the Systems Management Server repository (which can be located on the server the software runs on or the storage can be remotely located) or the like, for use if the same or similar problem is later encountered in the unique systems managed IT system.

### SUMMARY OF THE INVENTION

The invention generally provides a mechanism for use in resolving problems in a distributed systems managed information technology or computer system that has very specific characteristics, or is contained in a very unique environment. When the system operator receives an event alerting him to a failure or problem, the mechanism journals his solution of the problem by capturing his workflow, as he carries out successive steps or actions leading to problem resolution. The journaled resolution is then stored, together with a signature identifying the problem, for use if the same or similar problem is encountered in the future. Thus, the journaled resolution is tailored to the specific information technology system environment. One useful embodiment of the invention is directed to a method for problem resolution in an event managed IT system that has a very unique configuration. The method comprises identifying a system problem that has a characteristic signature, and carrying out a corrective procedure comprising a sequence or succession of steps, in order to fix the problem. A record is made of the succession of steps as they are respectively being performed. The method further comprises storing the succession of steps together with the characteristic problem signature. The problem signature is then used to identify a subsequent problem, whereupon the corrective procedure is applied to fix the subsequent problem.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram showing a unique information technology system, which is being monitored by a distributed Systems Management software, for use in illustrating an embodiment of the invention.

FIG. 2 is a block diagram showing a computer console for use with the system of FIG. 1, in further detail.

FIG. 3 is a flow chart illustrating steps of a procedure for an embodiment of the invention.

FIG. 4 is a flow chart illustrating steps of a procedure for a further embodiment of the invention.

### DETAILED DESCRIPTION OF THE PREFERRED EMBODIMENT

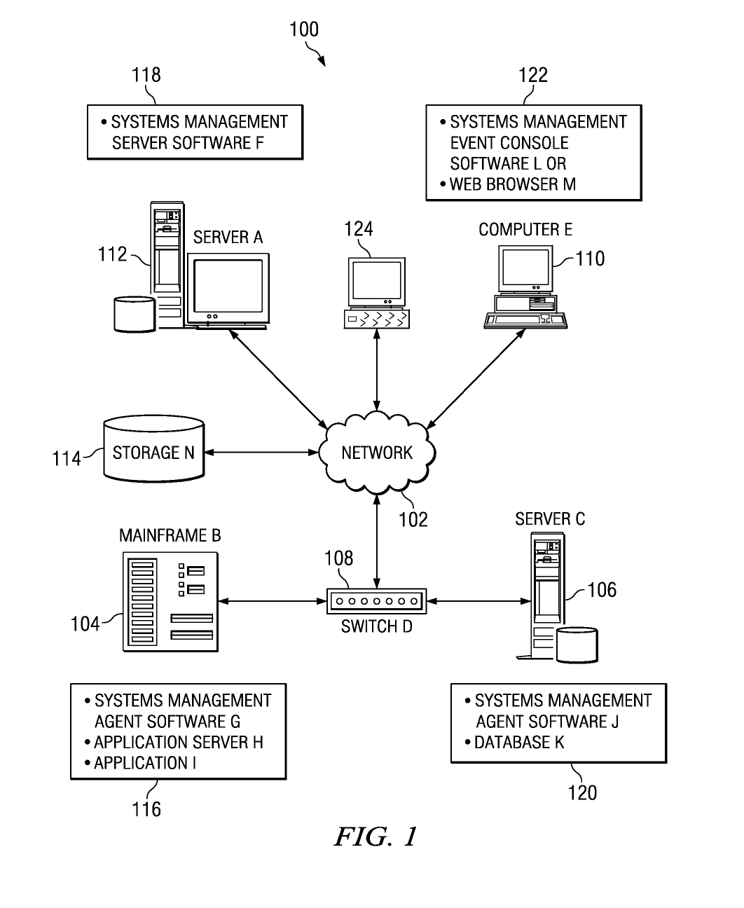

Referring to FIG. 1, there is shown an information technology system 100 connected to a network 102, such as the Internet, wherein system 100 is configured to provide a distributed computing environment. Distributed computing is parallel computing using multiple independent computers communicating over a network to accomplish a common objective or task. The type of hardware, programming languages, operating systems and other resources used in the system may vary drastically. FIG. 1 shows system 100 including a mainframe computer 104, a server 106, and a switch 108, also referenced for convenience as mainframe B, server C and switch D, respectively. FIG. 1 further shows a server 112, a computer console 110 and data storage 114 connected to network 102, these elements being additionally referenced as server A, computer E and storage N, respectively. Mainframe B, servers A and C and computer E are each provided with a respective systems management agent 116-122.

The environment of system 100 represents an enterprise who owns/runs a banking application, Application I. Application I is deployed on Application Server H, a program which runs on mainframe B. Application I uses a back-end database, database K, on server C, to store/retrieve all its banking data. Both server C and mainframe B are connected to the enterprise network by switch D. That is, mainframe B and server C are connected to the same subnet, “behind” switch D.

Users connected to the Internet can access the banking application via a web browser, to carry out tasks such as managing their finances, viewing their balance, depositing or withdrawing money and the like. When a user initiates a transaction via his web browser, be it to view his balance or make a withdrawal, the transaction takes the following steps:

### Step 1:

User types in “http://www.mybank.com/” on his web browser and hits “enter” on some computer 124 on the Internet. Usually he will also pass on his name and password.

### Step 2:

The request arrives at the enterprise's network, where it is routed to switch D.

### Step 3:

Switch D passes the request to mainframe B, where the banking application, Application I, receives the request, and does some internal programmed logic. It gets the name and password of the customer and does a request/look-up for the customer in its database, on database K, which is running on server C.

### Step 4:

Database K returns the query (the customer's information) to the banking application, Application I.

### Step 5:

The banking application I, gathers all the information pertaining to the request, puts it into a format viewable by a web browser, and returns the request to the customer on computer 124 via switch D.

### Step 6.

Switch D passes the request data onto the enterprise network, which ultimately finds its way to computer 124, where the customer sees his data; such as his account balance.

Every step of the above request/return procedure is a point of contention, where a failure might occur. Agents running on mainframe B and server C are constantly monitoring not only the server and mainframe itself, but the Application Server H, banking application-Application I, and database K. The systems management server F monitors network resources like switch D. Each resource being monitored, when it becomes apparent there is a problem, or is not performing to set levels, will set off an event/alarm that is gathered and displayed by the systems management server F.

An embodiment of the invention is illustrated by the following scenario, wherein the following events are received by the systems management server F:

“Application I response time has exceeded the threshold of 5 seconds.”

“Database K response time has exceeded the threshold of 10 seconds.”

“Database K has a table lock.”

Using an embodiment of the invention, a Subject Matter Expert (SME) would open an event console that is connected to the systems management server F, see the events, and open a troubleshooting window, (that can connect to server C and mainframe B via Agent software G and J). She notices that Application Server H and Application I are operating as expected but she notices that there is a lock on a table that Application I is trying to query on Database K; so she clicks on the button to start recording her mouse clicks and keystrokes, and stops and starts Database K (which could be done in many ways; but more importantly, since Database K is customized to this environment, she has the intimate knowledge of how to go about doing so, and the next time the journaled resolution runs, Database K is assured to be stopped and started correctly). She is satisfied the problem has been resolved and journals the resolution (that is now tied to the above events in the problem resolution matrix in various ways, e.g., event time stamps, frequency of events, time difference between events, etc.) on systems management server F. At some later time, the set of the above events, or subset thereof, can be used as a signature, to recognize occurrence of the same problem.

One or more events can constitute a signature. All events, in a preferred embodiment, are retrieved in a polling cycle, meaning the information technology System Management Server will not send an event until it is instructed to check the value or state of a monitor. If the monitor value or state is such that an event is necessary to alert an IT Systems Management operator, an event will be generated and sent to the Management Server's Event Console. In this type of environment, the monitor collects the events which are occurring in the monitored resource to derive the monitor value or state as a summary of the resource's condition. Other environments could collect the raw events and send them to the System Management Server at the appropriate time in the polling cycle. When a problem arises, and an SME is assigned to correct the problem, he/she uses the knowledge he/she has of the highly customized environment to ascertain, for example, what events are side effects to the real root cause of the problem. One preferred implementation of the event signature can be some sort of toggle switch that the SME can use to group what seem to be disparate events together to form the signature. The polling cycles of the monitors will determine the time window the SME will use to group the events. Typically, some monitors will have longer polling cycles than others, and those can be used as the determining factor for what the time window will be for grouping events and their use in the subsequent classification of the problem. The monitor with the longest polling cycle can be thought of as the slide ruler by which to look for the rest of the events in the event signature.

Once the SME selects the events which define the signature, the signature can be used as one of a set of signatures to identify problems. In a preferred embodiment, the IT System Management Server will have autonomic rules that will heuristically sort the event signatures by different ways, such as time scale (i.e. the event with the longest polling cycle), weight (the events that are most relevant to the problem), or possibly the order by which the events arrive or are shown. The invention can use these same rules to search for a problem signature. Thus, a search for a problem and its associated solution can be made by searching by a) events, e.g., starting with the longest polling cycle event and proceeding to the shortest one b) by weight, searching for the most relevant events first c) and by the order in which the events were received.

The next time events are received by systems management server F, they are analyzed against the problem resolution matrix of systems management server F, and if a match is made, the operator of system management server F is given the option to run the journaled resolution(s) to fix the problem at hand.

A “match” between the defined events within a signature and the detected events for a current problem depends on how the IT System Management operator or administrator defines a “match”. If a journaled resolution can fix a class of problems, then a match can occur whenever events that match a journaled resolution's events to a certain class or sub-class are detected. If the IT System Management administrator wants to be highly specific, the events in the event stream have to match those of the journaled resolution up to the device/resource that first sent the events. Thus, as an example, there is no “match” if both sets of events are merely related to a timeout of a WebSphere Application Server version 6.1 on Windows. Rather, for a match to occur, the WebSphere Application Server timeout event has to come from a particular server Y. As an even more restrictive match, all the rest of the events must come from server Y as well. In other embodiments, the presence of a particular event will increase the likelihood of a match, however, is not required for the interface to present the problem and solution as a possible match.

This invention has particular application to transaction related events as compared to resource related events, since transaction related events are the hardest ones to recognize, and depend heavily on how the information technology system environment is set up. Events that pertain to computer related resources and their status are more static in nature and therefore are easier to implement “out of the box”. That is, they are more likely to be already programmatically instructed in the IT System Management Server. Of course, where a solution has not been provided by the hardware or software manufacturer, the present invention can be applied. The present invention is particularly useful in highly customized environments, so that an SME does the troubleshooting and fix once, and other potentially less skilled operators use the journaled resolution to fix subsequent problems that are either exactly the same or closely related.

Transactions can be seen as a flow that touches certain resources and systems to complete the transaction from beginning to end. For example, the embodiment of the invention discussed above could pertain to a transaction, namely a banking transaction. That is why the word “signature” is used, since what appears to the naked untrained eye as a collection of disparate events from disparate sources actually is an event signature to the SME that has intimate knowledge of the IT environment. A transaction that is either not behaving to specification or is behaving incorrectly will leave an event trail that an SME can audit, to decisively and conclusively identify the real root problem.

Very frequently, System 100 will have a very unique configuration or characteristics. For example, Application I, mainframe B, server C and switch D may all be manufactured by different suppliers. In a generalized embodiment, as events occur in system 100, agents monitoring the system resources send events to the Systems Management Server F, whenever they encounter a problem. The Systems Management Server stores these events. An operator can use an event console, such as computer console 110, that runs on any machine connected to the enterprise network to connect to the Systems Management Server and display all the events that have been received and are being received. Actions can be initiated from this console, although it is the Systems Management Server (in conjunction with the agents running on the servers) that does the actual processing (work) of recording, capturing, storing, and execution of journaled resolutions.

As the components of system 100 are likely to be all different, it is difficult to package a solution to the problem beforehand, and it is likely that a generic or generalized problem solution will not be useful. Accordingly, the operator will have to manually fix the problem by performing a number of actions or steps, using the operator input devices. For example, if the problem is in the Switch D, the operator must first recognize the switch as the source of the trouble, and then work to resolve the problem.

In an embodiment of the invention, the operator's workflow is captured, via the management server and agents, as he performs a succession of actions to produce a problem fix. For example, successive keystrokes of keyboard 116 and clicks of mouse 120 may be journaled, or recorded, until the problem solution is complete. The captured operator workflow is then placed into a repository pertaining to the Systems Management Server, such as storage N shown in FIG. 1. Moreover, a problem such as malfunctioning switch D will have a certain pattern of events associated with it, wherein the pattern uniquely identifies the particular problem. Accordingly, the pattern of events serves as an effective problem signature, and is stored in the repository along with the captured workflow that resulted in the problem resolution. The resolution, which is tailored to the specific environment of system 100, can thus be readily referenced for use, if the same or similar problem occurs again in system 100, at some time in the future.

It will be understood that all events have certain attributes, such as class, possibility of several sub-classes, polling cycle (frequency of the IT System Management Server polling the monitored resource), minimum or maximum threshold/values. Those skilled in the art will appreciate that there can be other attributes, but these are among the most common. Thus, examples of events that could serve as a signature would be:
OS→System→CPU→Utilization
   where the root class is operating system, followed by the sub-class system, followed by the sub-subclass CPU (another sub-class of the system superset would be Disk, etc), and finally reaching the last sub-sub-sub-class Utilization (another sub-sub-sub class example is Time-Wait, etc.)
Value/Threshold−CPU Utilization

### Value that is set, say “90%”, where if the CPU Utilization value ever exceeds 90%, the condition is met.

Polling Cycle

The frequency by which the information technology system management server polls the resource to acquire the current value. If the polling cycle is set to “60 seconds”, then an information technology system operator is assured to receive an event after a minute if the CPU utilization ever reaches or exceeds 90%.
As a more specific example, if an IT system administrator wanted to monitor and ensure that CPU utilization on his/her desktop PC never goes above 85% in a span of two minutes, he/she could follow the steps:
Windows→NetVista→CPU→Utilization, set to 85%, and set polling cycle to 120 seconds.

The following is another example of an event (to monitor a database connection on an Application Server):
Application→Web→Application Server→JDBC connections→Timeout
   where the polling cycle could be set to 30 seconds. This monitor will check the Application Server every 30 seconds, to check if a database connection from the Application Server to the Database has timed out (meaning the Database did not return a request). A literal example would be as follows:
Application→WebSphere Application Server→JDBC Connections→Timeout

The degree to which a signature needs to be unique is a question of implementation of the invention. The invention relies heavily on the fact that most enterprise information technology systems are highly customized, i.e. generating highly customized events. The events allow an administrator to be very specific in establishing the signature and subsequently identifying the proper solution to the problem. The solution may or may not be widely applicable throughout the enterprise. Therefore, it is up to the IT System Management administrator to define how loosely coupled he/she wants the signatures to be, i.e. how closely the event signatures must match and at what class/subclass level they must match. The IT System Management administrator can decide that a problem solution and its associated signature can be used for a single problem, or a class of problems. As described above, events can be highly explicit, pointing to a single resource on a single system. For example, all devices hooked up to a network have a distinct IP address, and there can only be one resource named “F” on IP address R.

For example, there can be a signature (with a journaled resolution) to fix the email client on a particular desktop PC included in an office network of desktop PCs. It is first assumed that all the PCs in the office have the same email client and are configured alike. In this case, the administrator knows that he can use a journaled resolution that was a fix for the particular PC to fix any other PC in the office. However, it could be the case that every email client in the office is different. Therefore, the administrator would know to use the journaled resolution to fix the mail client of the particular PC in a very precise manner, when the event signature points to only the email client on the particular PC, and not just any event signature pointing to an email client on another PC at the office.

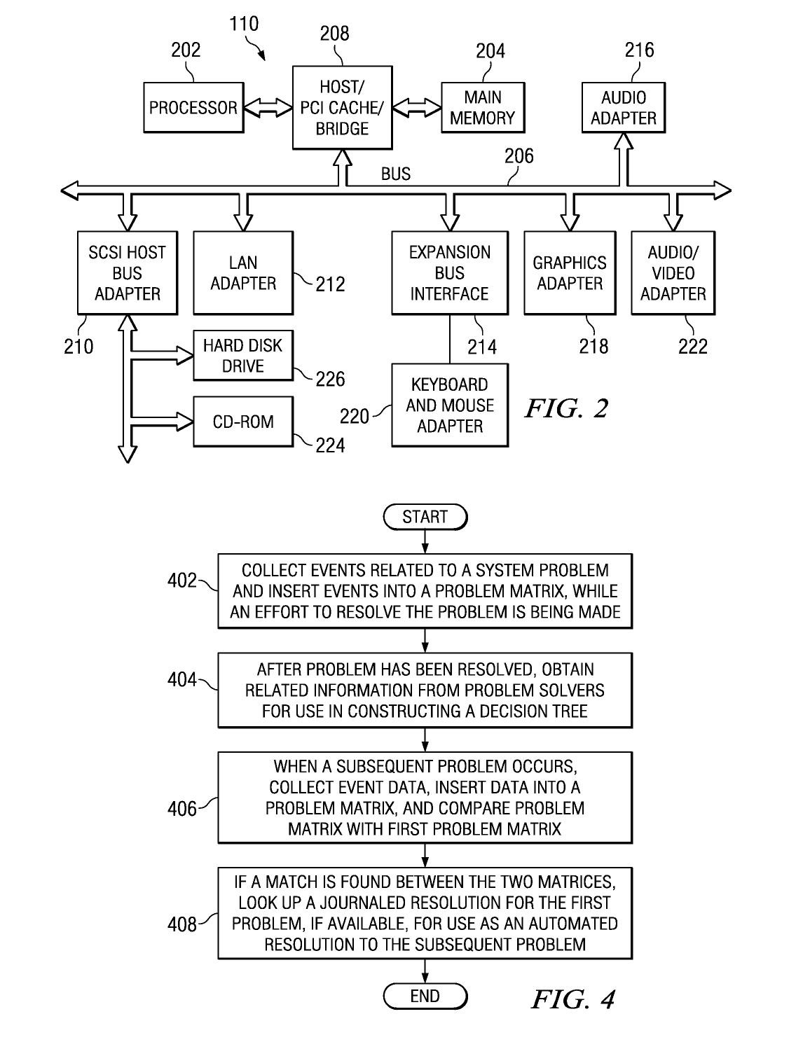

Referring to FIG. 2, there is shown a block diagram depicting computer console 110 as a generalized computer or data processing system. Computer console 110 usefully employs a peripheral component interconnect (PCI) local bus architecture, although other bus architectures may alternatively be used. FIG. 2 shows a processor 202 and main memory 204 connected to a PCI local bus 206 through a Host/PCI bridge 208. PCI bridge 208 also may include an integrated memory controller and cache memory for processor 202.

Referring further to FIG. 2, there is shown a local area network (LAN) adapter 212, a small computer system interface (SCSI) host bus adapter 210, and an expansion bus interface 214 respectively connected to PCI local bus 206 by direct component connection. Expansion bus interface 214 provides a connection for a keyboard and mouse adapter 220. Audio adapter 216, a graphics adapter 218, and audio/video adapter 222 are connected to PCI local bus 206 by means of add-in boards inserted into expansion slots. SCSI host bus adapter 210 provides a connection for hard disk drive 226, and also for CD-ROM drive 224.

An operating system runs on processor 202 and is used to coordinate and provide control of various components within data processing system 110 shown in FIG. 2. The operating system may be a commercially available operating system such as Windows XP, which is available from Microsoft Corporation. Instructions for the operating system and for applications or programs are located on storage devices, such as hard disk drive 226, and may be loaded into main memory 204 for execution by processor 202.

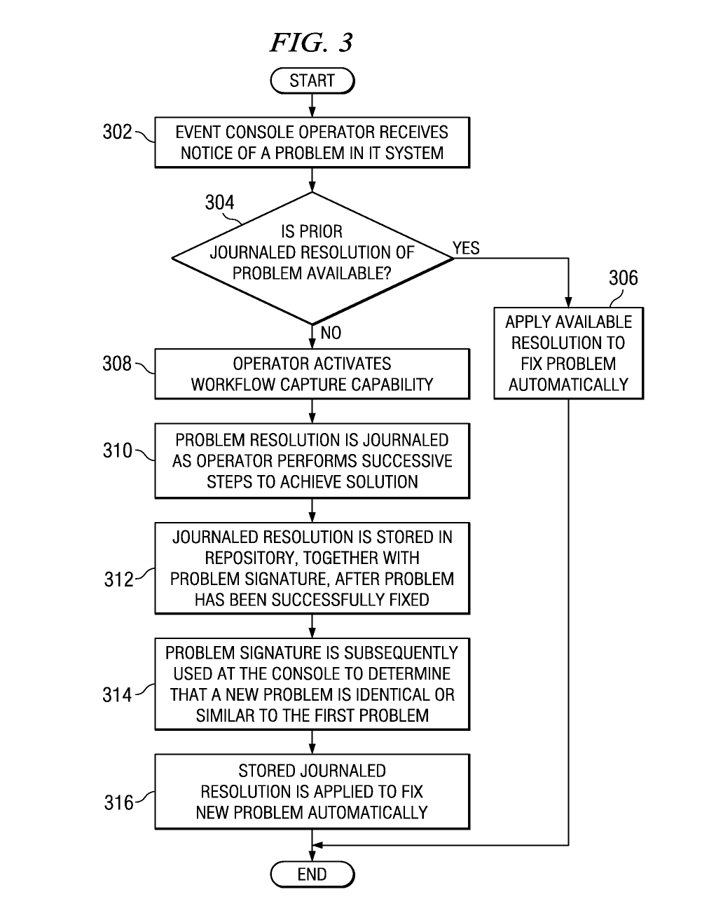

Referring to FIG. 3, there are shown successive steps in accordance with an embodiment of the invention. At step 302, the operator of computer console 110 receives an alarm alerting him to a problem in the IT system. Accordingly, as indicated by step 304, it becomes necessary to determine whether a resolution to the problem was previously journaled, so that it is now available. If the determination is positive, the console operator can apply the prior journaled resolution, in order to fix the problem automatically as shown by step 306.

As stated above, the determination of a match to a previously journaled resolution depends on how the operator or administrator defines it. If a journaled resolution can fix a class of problems, then a match can be those events that match a journaled resolution's events, down to a certain class or sub-class level. If the administrator defines the match to be very specific, the events in the event stream have to match those of the journaled resolution up to the device/resource that first sent the events. When a problem first arises, and the operator troubleshoots the issue and is certain what the cause is, so that he/she can look at an event flow and pick out the events that are germane to the problem, then that the selected events constitute a signature. The IT administrator defines what problem signature can be used for a single problem, or for a class of problems. Nonetheless, the operator currently confronted with the problem must determine whether the proffered solution is the correct one. In an alternative embodiment of the invention, there is an option for a later operator to further refine the signature. For example, if the administrator has defined a match for a class of problems and a later operator determines that the solution is inapplicable for a particular system, the signature can be modified so that the solution is not offered for that system in the future.

Referring further to FIG. 3, if there is no prior journaled resolution in the repository of the systems management software, the operator can activate the workflow capture capability of console 110, as indicated at step 308. In accordance with step 310, successive steps or actions of the operator's solution are journaled or recorded, such as by capturing keystrokes and mouse clicks. After the operator successfully solves the problem, the operator can save the journaled fix in the data store or repository of the systems management software, which may reside in storage 122 or elsewhere. The journaled resolution is stored in the repository together with the problem signature, as shown by step 312. This creates an automated solution to a problem signature that will be available the next time an event or alarm provides notice that the same problem has occurred. Thus, the next time that the same or similar problem arises, the operator can decide to either manually fix the problem, or to automate the resolution by means of the journaled fix stored in the repository of the systems management software. This is set forth at steps 314 and 316.

It could be useful to have an operator or SME provide comments, help text or metadata associated with a problem resolution that could be used for searching in the future. Accordingly, in some implementations of the invention, the operator could utilize a mechanism on the event console to do any of the following, in connection with a journaled resolution:

Group (by way of a toggle switch for example) the event(s) that are relevant to the problem signature

Classify each event in the “event group” as either root cause or incidental anciliatory

Mark (for each event if the SME wishes to) how explicit the event should be (from the top class all the way to the source of the event, i.e. top class == Application or all the way to the last sub-class). This could help the SME to explicitly decide how general each event can be, when searching the problem signatures or creating the problem signatures.

In some embodiments of the invention, it would be useful to record keystrokes and mouse clicks via playback using technology such as a product of the International Business Machines Corporation (IBM) known as Rational Robot. A product of this type allows the journaled resolution to be tweaked and edited, just like a film or audio recording. Thus, if the journaled resolution was inexact, so that manual user intervention was required, this product could be used to edit resolution parameters, or provide new parameters altogether. In one implementation, each step in the journaled resolution is segmented so that a fix can be applied in subsequent steps, rather than in just one run/playback.

Referring to FIG. 4, there are shown steps of an alternative approach for recognizing similarity between a resolved problem and a subsequently occurring problem. At step 402, events relating to a problem of system 100 are collected by an agent, and inserted into a problem matrix, while an effort to resolve the problem is being made. As indicated at step 404, after resolution has been completed, related information is obtained from those who solved the problem. For example, a series of questions could be presented to those who worked on the problem, based on data collected from the event stream. The information provided from the questions would then be used to form a structured decision tree. Subsequently, when a new problem arises, the agent would collect the incoming event data, insert the data into a problem matrix, and compare the new problem matrix with the first problem matrix. This is shown by step 406. When a match is found, the matrices serve as a problem signature that identifies both problems. In accordance with step 408, a journaled resolution would be looked up. If a resolution exists, it would be presented to the operator as a possible automated resolution. A further option would allow the result to feed an automation tool, or update a management tool with additional possible operator actions.

In a modification of the above embodiment, when the two problem matrices are compared, the match therebetween could be expressed as a numerical value. For example, an exact match would be 100%, and a lesser degree of matching would be a reduced percentage value. Accordingly, a numerical limit could be pre-selected. In computing a percentage, it is to be noted that a given problem signature has X number of root-cause events and Y number of incidental events. When comparing two problem matrices, the total number of X root cause events of the current problem can be compared to the total number of X root cause events of the problem signature with the journaled resolution. Suppose the matching rule is that the detected root cause events must be less than or equal in number than in the problem signature and match in identity for a match to be declared. If the current problem has more than X root cause events, they are not a match. If the total number of X root cause events are the same (and the events themselves are the same) then they are an exact match, 100%. If the current problem only has two root cause events and the problem signature with the journaled resolution has 3, then it is a 66% match, etc. If the match between the problem signature and the detected event set was found to be no less than the pre-selected limit, the two problems would be considered to be fairly similar. Accordingly, it would be worth presenting the journaled resolution for the first problem as a possibility to fix the new problem. If the match was less than the pre-selected limit, the journaled resolution would not be used.

The invention can take the form of an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for problem resolution in a distributed systems managed information technology (IT) system having a specific configuration, wherein said method comprises:
identifying a system problem that has a characteristic signature;
carrying out a corrective procedure comprising a succession of steps to fix said problem;
making a record of said succession of steps as they are respectively performed;
storing said succession of steps together with said characteristic signature of said problem; and
using said signature to identify a solution to a subsequent problem, whereupon said corrective procedure is used to fix said subsequent problem.

2. The method of claim 1, wherein:
said characteristic problem signature comprises a specific pattern of events.

3. The method of claim 1, wherein:
said succession of steps are initiated by operation of an event management console connected to said IT system.

4. The method of claim 3, wherein:
said recording, storing and using tasks are performed by a systems management server associated with said IT system.

5. The method of claim 4, wherein:
recording said successive steps includes capturing keyboard strokes and mouse clicks that occur during the operation of said console in carrying out said corrective procedure.

6. The method of claim 2, wherein:
said specific pattern of events is used in forming a first problem matrix for use in identifying said subsequent problem.

7. The method of claim 6, wherein:
identification of said subsequent problem comprises appointing an agent to collect incoming event data resulting from said subsequent problem, forming a second problem matrix from said collected event data, and comparing said first and second problem matrices, to determine whether there is a match therebetween.

8. The method of claim 7, wherein:
when a match is found between said first and second problem matrices, said agent automatically applies said succession of steps to resolve said subsequent problem.

9. The method of claim 7, wherein:
said agent automatically applies said succession of corrective steps to resolve said subsequent problem, when and only when a match between said first and second problem matrices is found to be no less than a pre-selected limit.

10. A computer program product in a computer readable medium for problem resolution in a distributed systems managed information technology (IT) system having a specific configuration, said computer program product comprising:
first instructions for identifying a system problem that has a characteristic signature;
second instructions for carrying out a corrective procedure comprising a succession of steps to fix said problem;
third instructions for making a record of said succession of steps as they are respectively performed;
fourth instructions for storing said succession of steps together with said characteristic signature of said problem; and
fifth instructions for using said signature to identify a solution to a subsequent problem, whereupon said corrective procedure is used to fix said subsequent problem.

11. The computer program product of claim 10, wherein:
said characteristic problem signature comprises a specific pattern of events.

12. The computer program product of claim 10, wherein:
said succession of steps are initiated by operation of an event management console connected to said IT system.

13. The computer program product of claim 12, wherein:
said recording, storing and using tasks are performed by a systems management server associated with said IT system.

14. The computer program product of claim 13, wherein:
recording said successive steps includes capturing keyboard strokes and mouse clicks that occur during the operation of said console in carrying out said corrective procedure.

15. The computer program product of claim 11, wherein:
said specific pattern of events is used in forming a first problem matrix for use in identifying said subsequent problem.

16. Apparatus for problem resolution in a distributed systems managed information technology (IT) system having a specific configuration, said apparatus comprising:
a first processor component adapted to recognize a characteristic problem signature that identifies a particular problem;
one or more input devices for use in carrying out a corrective procedure comprising a succession of steps to fix said problem;
a repository for storing a record made of said steps as they are respectively performed, together with said characteristic signature of said problem; and
a second processor component adapted to use said signature to identify a solution to a subsequent problem, and to thereupon use said corrective procedure to fix said subsequent problem.

17. The apparatus of claim 16, wherein:
said first processor component is adapted to recognize a characteristic problem signature that comprises a specific pattern of events.

18. The apparatus of claim 16, wherein:
said first and second processor components and said repository are respectively included with a systems management server associated with said IT system.

19. The apparatus of claim 18, wherein:
said systems management server includes a component for recording said succession of steps as they respectively occur.

20. The apparatus of claim 19, wherein:
said recording component records said succession of steps by capturing keyboard strokes and mouse clicks that occur during the operation of said input devices by said operator to fix said problem.
